(19) United States
(12) Patent Application Publication
(10) Pub. No.: US 2025/0105446 A1
(43) Pub. Date: Mar. 27, 2025

(54) SEPARATOR FOR RECHARGEABLE LITHIUM BATTERY AND RECHARGEBALE LITHIUM BATTERY INCLUDING SAME

(71) Applicant: SAMSUNG SDI CO., LTD., Gyeonggi-do (KR)

(72) Inventors: Hyeonseon CHOI, Gyeonggi-do (KR); Jinyoung KIM, Gyeonggi-do (KR); Dongwan SEO, Gyeonggi-do (KR)

(73) Assignee: SAMSUNG SDI CO., LTD., Gyeonggi-do (KR)

(21) Appl. No.: 18/730,606

(22) PCT Filed: Feb. 17, 2023
(86) PCT No.: PCT/KR2023/002351

§ 371 Date: Jul. 19, 2024

(30) Foreign Application Priority Data
Apr. 15, 2022 (KR) 10-2022-0047169

(51) Int. Cl. H01M 50/446; H01M 50/417; H01M 50/42; H01M 50/423; H01M 50/426; H01M 50/434; H01M 50/491

(52) U.S. Cl. CPC H01M 50/446; H01M 50/417; H01M 50/42; H01M 50/423; H01M 50/426; H01M 50/434; H01M 50/491

(57) ABSTRACT

A separator for a rechargeable lithium battery and a rechargeable lithium battery including the same are provided, and the separator for a rechargeable lithium battery comprises: a porous substrate; and a coating layer disposed on at least one surface of the porous substrate and comprising first polyethylene particles, second polyethylene particles, and ceramics, wherein the ratio of the average size of the second polyethylene particles to the average size of the first polyethylene particles ranges from 25 to 80%.

### CROSS-REFERENCE TO RELATED APPLICATION

This application claims priority to and the benefit of Korean Patent Application No. 10-2022-0047169 filed in the Korean Intellectual Property Office on Apr. 15, 2022, the entire contents of which are incorporated herein by reference.

### TECHNICAL FIELD

It relates to a separator for a rechargeable lithium battery and a rechargeable lithium battery including the same.

### BACKGROUND ART

Rechargeable lithium batteries have a high discharge voltage and high energy density, and are attracting attention as a power source for various electronic devices.

A rechargeable lithium battery is arranged so that the positive and negative electrodes may face each other, has a structure filled with an electrolyte, and a separator is located between the positive and negative electrodes to prevent short circuit. The separator may be a porous material that may transfer ions or electrolytes.

If a battery is exposed to a high temperature environment due to abnormal behavior, a separator may mechanically shrink or be damaged due to melting characteristics at a low temperature. Herein, the positive and negative electrodes contact each other and may cause an explosion of the battery. In order to solve the problems, technology is needed to suppress shrinkage of the separator and ensure the safety of the battery.

### Technical Problem

One embodiment is to provide a separator for a rechargeable lithium battery with excellent safety.

Another embodiment provides a rechargeable lithium battery including the separator.

### Technical Solution

According to one embodiment, a separator for a rechargeable lithium battery including a porous substrate; and a coating layer disposed on at least one surface of the porous substrate and including first polyethylene particles, second polyethylene particles, and ceramics, wherein the ratio of the average size of the second polyethylene particles to the average size of the first polyethylene particles ranges from 25% to 80%, is provided.

The average size of the first polyethylene particle may be 1 μm to 2 μm.

The average size of the second polyethylene particle may be 0.5 μm to 0.8 μm.

A weight average molecular weight (Mw) of the first polyethylene particle or the second polyethylene particle may be 1000 g/mol to 5000 g/mol.

A mixing ratio of the first polyethylene particle and the second polyethylene particle may be 70:30 to 95:5 by weight ratio.

The ceramics may be Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The coating layer may further include an aqueous binder. The aqueous binder may be a styrene-butadiene rubber, an acrylated styrene-butadiene rubber, polyvinyl alcohol, sodium polyacrylate, a copolymer of propylene and a C2 to C8 olefin, polyacryl amide, a copolymer of (meth)acrylic acid and (meth)acrylic acid alkyl ester, or a or combination thereof.

The coating layer may have a thickness of 0.5 μm to 5 μm on one side.

The separator may further include an adhesive layer formed on one surface of the coating layer.

The adhesive layer may include a fluorine-included binder, a vinyl group-containing binder, or a combination thereof.

The fluorine-Included binder may be a polyvinylidene fluoride binder, a polyvinylidene fluoride-hexafluoropropylene copolymer binder, polytetrafluoroethylene binder, or a combination thereof.

The vinyl group-containing binder may be (meth)acrylic acid, methyl(meth)acrylate, (meth)acrylonitrile, (meth)acrylamidosulfonic acid, (meth)acrylamidosulfonate salt, or a combination thereof.

The adhesive layer may have a thickness of 0.1 μm to 4 μm on one side.

According to another embodiment, a rechargeable lithium battery including a negative a negative electrode including a negative active material; a positive electrode including a positive active material; the separator located between the negative electrode and the positive electrode; and a non-aqueous electrolyte.

Details of other embodiments are included in the detailed description below.

### Advantageous Effects

A separator for a rechargeable lithium battery according to one embodiment may exhibit excellent safety.

### BRIEF DESCRIPTION OF THE DRAWINGS

FIG. 1 is a view briefly showing a rechargeable lithium battery according to an embodiment.

### DETAILED DESCRIPTION OF THE EMBODIMENTS

Hereinafter, embodiments of the present invention are described in detail. However, these embodiments are exemplary, the present invention is not limited thereto and the present invention is defined by the scope of claims. The terminology used herein is used to describe embodiments only, and is not intended to limit the present disclosure. The singular expression includes the plural expression unless the context clearly dictates otherwise.

“Combination thereof” means a mixture, laminate, composite, copolymer, alloy, blend, reaction product, and the like of the constituents.

As used herein, it should be understood that terms such as “comprise”, “include” or “have” are intended to designate the presence of an embodied feature, number, step, element, or a combination thereof is present, but it does not preclude the possibility of presence or addition of one or more other features, number, step, element, or a combination thereof.

The drawings show that the thickness is enlarged in order to clearly show the various layers and regions, and the same reference numerals are given to similar parts throughout the specification. If an element, such as a layer, a film, a region, a plate, and the like is referred to as being “on” or “over” another part, it may include cases where it is “directly on” another element, but also cases where there is another element in between. In contrast, when an element is referred to as being “directly on” another element, there are no intervening elements present.

“Thickness” may be measured through an image taken with an optical microscope such as a scanning electron microscope.

The average size may refer to an average particle diameter (D50), and in the present specification, when a definition is not otherwise provided, an average particle diameter (D50) indicates a particle where a cumulative volume is about 50 volume % in a particle distribution.

The average particle size (D50) may be measured by a method well known to those skilled in the art, for example, by a particle size analyzer, or by a transmission electron microscopic image, or a scanning electron microscopic image. In some embodiments, a dynamic light-scattering measurement device is used to perform a data analysis, and the number of particles is counted for each particle size range, and from this, the average particle diameter (D50) value may be easily obtained through a calculation.

One embodiment includes a porous substrate and a coating layer disposed on at least one surface of the porous substrate and including first polyethylene particles, second polyethylene particles, and ceramics. For example, the ratio of the average size of the second polyethylene particles to the average size of the first polyethylene particle may be 25% to 80%, 41% to 75%, 50% to 75%, 55% to 70%, 55% to 65%. For example, the ratio of the average size of the second polyethylene particle/the average size of the first polyethylene particle may be 25% to 80%, 41% to 75%, 50% to 75%, 55% to 70%, 55% to 65%.

The polyethylene particles do not melt during normal charging and discharging within the battery, but when a high temperature phenomenon occurs within the battery, they melt before the porous substrate above the melting temperature and block the pores within the porous substrate to block the movement of ions, induce a quick shutdown function, and ensure the safety of the secondary battery. To explain this in more detail, the melting temperature of polyethylene particles is 100° C. to 120° C., which is approximately 30° C. lower than the melting temperature of the porous substrate, and thus, when a high temperature phenomenon occurs in the battery, they may melt before the porous substrate.

Such shutdown effects owing to the melting of polyethylene particles may be more greatly obtained in a coating layer including bimodal polyethylene particles with different average sizes, e.g., large particles with larger average particle size and small particles with smaller average particle size and having the ratio of the average particle size of the second polyethylene particles/the average size of the first polyethylene particles within the above range. Particularly, the inclusion of the bimodal polyethylene particles with the ratio of the average particle size of the second polyethylene particles/the average particle size of the first polyethylene particles within the above range may render to secure the air permeability and the shutdown effects. Furthermore, the ionic conductivity may be also improved.

If the polyethylene particles all have the same average sizes, or even if particles of different are used, or if both the large and small particles are not made of polyethylene, the ionic conductivity may be deteriorated or the shutdown effects may be deteriorated. In addition, even if the particles with the different size, such as a larger particle and a smaller particle, are included, the ratio between the sizes out of the range may lead to a decrease in ionic conductivity or a deterioration in the shutdown effects.

In one embodiment, the average size of the first polyethylene particles may be 1 μm to 2 μm, 1 μm or more and less than 2 μm, 1 μm to 1.5 μm, 1 μm to 1.2 μm, or 1 μm to 0.1 μm. The average size of the second polyethylene particles may be 0.5 μm to 0.8 μm, 0.5 μm to 0.75 μm, 0.6 μm to 0.75 μm, or 0.6 μm to 0.7 μm.

If the average sizes of the first polyethylene particles and the second polyethylene particles are within the range, the density of the coating layer may be increased and the wettability for the electrolyte may be enhanced, thereby increasing the ionic conductivity.

In one embodiment, the polyethylene particles may be in a wax form. At this time, the wax form, that is, polyethylene wax, means that the molecular weight is larger than that of an oligomer and smaller than that of a polymer, and for example, the weight average molecular weight (Mw) may be 1000 g/mol to 5000 g/mol, 1000 g/mol to 3000 g/mol, or 1500 g/mol to 3000 g/mol. If the weight average molecular weight of the polyethylene particles is within this range, the deformation of particles may be rarely occurred after fabricating the battery and there may be excellent shutdown.

In one embodiment, the shape or size of the polyethylene particles does not need to be limited.

In one embodiment, a mixing ratio of the first polyethylene particles and the second polyethylene particles may be 70:30 to 95:5 by weight ratio, 75:25 to 95:5 by weight ratio, 80:20 to 95:5 by weight ratio, or 90:10 to 95:5 by weight ratio. If the weight ratio of the first polyethylene particles and the second polyethylene particles is within the range, the suitable ionic conductivity and air permeability characteristic may be exhibited. Furthermore, by using a larger amount of the first polyethylene particles, which are larger, than the second polyethylene particles, which are smaller, air permeability may be well secured without increasing resistance.

In addition, the ceramic may be cubic, plate-shaped, spherical, or irregular, and its shape does not need to be limited.

The ceramics may be Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

An average size of the ceramics may be 0.1 μm to 2 μm, 0.2 μm to 1.5 μm, 0.5 μm to 1.5 μm, 0.5 μm to 1.0 μm, but is not limited thereto.

The coating layer further includes an aqueous binder. For example, a styrene-butadiene rubber, an acrylated styrene-butadiene rubber, polyvinyl alcohol, sodium polyacrylate, a copolymer of propylene and a C2 to C8 olefin, polyacrylamide, a copolymer of (meth)acrylic acid and (meth)acrylic acid alkyl ester, or a combination thereof.

If the coating layer further include the aqueous binder, an amount of the aqueous binder may be, based on the total 100 wt % of the coating layer, 10 wt % to 1 wt %, or 6 wt % to 4 wt %. If the amount of the aqueous binder is within the range, the particles may be firmly fixed in the coating layer, the coating layer may be well adhered on the porous substrate and the appropriate porosity may be also secured after coating.

In one embodiment, the thickness of the coating layer on one side may be 0.5 μm to 5 μm, and for example 1 μm to 5 μm, 1 μm to 4 μm, 1 μm to 3 μm, 1 μm to 2 μm. If the thickness of the coating layer on one side is within the range, the separator may be provided enhanced shutdown function and air permeability and the thickness of the electrode assembly may be minimized, thereby maximizing capacity per volume of the battery.

The separator may further include an adhesive layer formed on one surface of the coating layer.

The adhesive layer may include a fluorine-included binder, vinyl group-containing binder, or a combination thereof.

The fluorine-included binder may be a polyvinylidene fluoride binder, a polyvinylidene fluoride-hexafluoropropylene copolymer binder, a polytetrafluoroethylene binder, or a combination thereof.

The vinyl-containing binder may be (meth)acrylic acid, methyl(meth)acrylate, (meth)acrylonitrile, (meth)acrylamido sulfonic acid, (meth)acrylamidosulfonate salt, or a combination thereof. According to one embodiment, the vinyl group-containing binder may include a (meth)acrylic copolymer including a first structural unit derived from (meth)acrylamide, and a second structural unit including at least one of a structural unit derived from (meth)acrylic acid, (meth)acrylate, (meth)acrylonitrile, or a combination thereof, and a structural unit derived from (meth)acrylamidosulfonic acid, a (meth)acrylamidosulfonate salt, or a combination thereof.

In this specification, ‘(meth)acrylic’ means acrylic or methacrylic.

The first structural unit derived from (meth)acrylamide includes an amide functional group (—NH₂) within the structural unit. The —NH₂ functional group may improve adhesion characteristics with the porous substrate and electrode, and may more firmly fix the first inorganic particles in the coating layer by forming a hydrogen bond with the —OH functional group of the first inorganic particles, which will be described later, and thus, the heat resistance of the separator may be strengthened.

The structural unit derived from (meth)acrylic acid, (meth)acrylate, (meth)acrylonitrile, or a combination thereof included in the second structural unit is used to fix the polyethylene particles and the first ceramic particles on the porous substrate and at the same time, it may provide an adhesive force so that the coating layer adheres well to the porous substrate and electrode, and may contribute to improving the heat resistance and air permeability of the separator. In addition, by including a carboxyl functional group (—C(═O)O—) in the structural unit, dispersibility of the coating slurry may be improved, and by including a nitrile group, oxidation resistance of the separator may be improved and the moisture amount may be reduced.

In addition, the structural unit derived from (meth)acrylamidosutfonic acid, (meth)acrylamidosulfonic acid salt, or a combination thereof included in the second structural unit includes a bulky functional group, thereby reducing mobility of the copolymer including it and thus strengthening heat resistance of the separator.

The porous substrate has a large number of pores and may be a substrate commonly used in batteries. The porous substrate may include any one selected from polyolefin such as polyethylene and polypropylene, polyester such as polyethylene terephthalate and polybutylene terephthalate, polyacetal, polyamide, polyimide, polycarbonate, polyetheretherketone, polyaryletherketone, polyetheimide, polyamideimide, polybenzimidazole, polyethersulfone, polyphenyleneoxide, a cyclic olefin copolymer, polyphenylenesulfide, polyethylenenaphthalate, a glass fiber, TEFLON, and polytetrafluoroethylene, or a copolymer or mixture of two or more types thereof.

In one embodiment, the porous substrate may include polyolefin. The porous substrate including polyolefin may include, for example, a polyethylene single film, a polypropylene single film, a polyethylene/polypropylene double film, a polypropylene/polyethylene/polypropylene triple film, or a polyethylene/polypropylene/polyethylene triple film.

A thickness on one side of the adhesive layer may be 0.1 μm to 4 μm, for example, 0.1 μm to 3.0 μm, 0.1 μm to 2.0 μm, 0.1 μm to 1.0 μm, and for example, 0.3 μm to 1.0 μm, 0.4 μm to 1.0 μm, 0.4 μm to 0.9 μm, or 0.5 μm to 0.9 μm. If the thickness on one side of the adhesive layer is within the range, the adherence between the coating layer and the electrode may be effectively provided.

The porous substrate may have a thickness of 1 μm to 40 μm, for example, 1 μm to 30 μm, 1 μm to 20 μm, 5 μm to 15 μm, or 5 μm to 10 μm. If the thickness of the porous substrate is within the range, the mechanical properties of the separator may be satisfied and the ratio of the active material may be increased in the battery, thereby enhancing capacity per the unit volume.

A separator for a rechargeable lithium battery according to an embodiment may be manufactured by various known methods. For example, in a separator for a rechargeable lithium battery, a coating layer forming composition is coated on one or both surfaces of a porous substrate and then dried to form a coating layer, and the composition for forming an adhesive layer may be coated on one surface of the coating layer and then dried to form an adhesive layer.

The coating layer forming composition may include ceramics, first polyethylene particles, second polyethylene particles, and a solvent, and may further include an aqueous binder. The solvent is not particularly limited as long as it may dissolve or disperse the ceramics, the polyethylene particle, and the aqueous binder. In one embodiment, the solvent may be an aqueous solvent including water, alcohol, or a combination thereof. The alcohol may be methyl alcohol, ethyl alcohol, propyl alcohol, or a combination thereof.

The coating layer forming composition may be prepared by adding the ceramics and the aqueous binder to a solvent and mixing to prepare a ceramic/binder liquid and admixing the first polyethylene particles, the second polyethylene particles, and a second aqueous binder, and a solvent to the ceramic/binder liquid. The first aqueous binder may be used in a solid or liquid form, and the second aqueous binder may also be used in a solid or liquid form. If the first and the second aqueous binder, the curable binder, and the aqueous binder are used in a liquid form, the solvent may be an aqueous solvent including water, alcohol, or a combination thereof. The alcohol may be methanol, ethanol, propyl alcohol, or a combination thereof. The first polyethylene particles and the second polyethylene particles may be used in a liquid form and in this case, the solvent may be water, alcohol, or a combination thereof. The alcohol may be methanol, ethanol, propyl alcohol, or a combination thereof.

If the first aqueous binder is used in a liquid form, a concentration thereof may be 10 wt % to 30 wt %, and if the second aqueous binder is used in a liquid form, a concentration thereof may be 10 wt % to 30 wt %. In addition, if the first and the second polyethylene particles are used in liquid form, a concentration thereof may be 30 wt % to 40 wt %.

The first and the second aqueous binder may be the aqueous binder described above, and may be the same or different each other.

In the composition for forming a coating layer, a mixing ratio of the materials used may be adjusted appropriately, and there is no need to specifically limit it.

Additionally, the mixing process may be performed through a milling process such as a bead mill or ball mill, but is not limited thereto.

The coating may be performed by, for example, spin coating, dip coating, bar coating, die coating, slit coating, roll coating, inkjet printing, etc., but is not limited thereto.

The drying may be performed by, for example, natural drying, drying with warm air, hot air or low humidity air, vacuum drying, irradiation with far-infrared rays, electron beams, etc., but is not limited thereto. The drying process may be performed at a temperature of, for example, 25° C. to 120° C.

The composition for forming an adhesive layer may include a binder and a solvent. The solvent may be an aqueous solvent including water, alcohol, or a combination thereof. The alcohol may be methanol, ethanol, propyl alcohol, or a combination thereof. The binder may be the fluorine-included binder, a vinyl group-containing binder, and or a combination thereof.

Another embodiment provides a lithium secondary battery including a negative electrode, a positive electrode, a separator between the negative electrode and the positive electrode, and an electrolyte.

The separator is a separator according to one embodiment.

The negative electrode includes a current collector and a negative active material layer formed on the current collector and including the negative active material.

The negative active material may be a material that reversibly intercalates/deintercalates lithium ions, a lithium metal, a lithium metal alloy, a material capable of doping/dedoping lithium, or a transition metal oxide.

Examples of the material that reversibly intercalates/deintercalates lithium ions include a carbon material, that is, a carbon-based negative active material commonly used in lithium secondary batteries. Representative examples of carbon-based negative active materials may include crystalline carbon, amorphous carbon, or a combination thereof. Examples of the crystalline carbon may include graphite such as unspecified shaped, plate-shaped, flake, spherical or fibrous natural graphite or artificial graphite, and examples of the amorphous carbon may include soft carbon, hard carbon, mesophase pitch carbonized product, calcined coke, etc.

The lithium metal alloy may include an alloy of lithium and a metal selected from Na, K, Rb, Cs, Fr, Be. Mg, Ca, Sr, Si, Sb, Pb, In, Zn, Ba, Ra, Ge, Al, and Sn.

The material capable of doping/dedoping lithium may be Si, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), a Si-carbon composite. Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, but not Sn), a Sn-carbon composite, and the like, and additionally, at least one of these may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

The titanium metal oxide may be lithium titanium oxide.

The negative active material according to one embodiment may include a Si—C composite including a Si-based active material and a carbon-based active material.

The Si-based active material may be Si, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), or a combination thereof.

An average particle diameter of the Si-based active material may be 50 nm to 200 nm.

If the average particle diameter of the Si-based active material is within the above range, volume expansion that occurs during charging and discharging may be suppressed, and disconnection of the conductive path due to particle crushing during charging and discharging may be prevented.

The Si-based active material may be included in an amount of 1 wt % to 60 wt %, for example 3 wt % to 60 wt %, based on a total weight of the Si—C composite.

The negative active material according to another embodiment may further include crystalline carbon along with the Si—C composite described above.

If the negative active material includes a Si—C composite and crystalline carbon, the Si—C composite and crystalline carbon may be included in the form of a mixture, in which case the Si—C composite and crystalline carbon may be included in a weight ratio of 1:99 to 50:50. More specifically, the Si—C composite and crystalline carbon may be included in a weight ratio of 5:95 to 20:80.

The crystalline carbon may include, for example, graphite, and more specifically, may include natural graphite, artificial graphite, or a mixture thereof.

An average particle diameter of the crystalline carbon may be 5 μm to 30 μm.

In this specification, the average particle diameter may be the particle size (D50) at 50 volume % in the cumulative size-distribution curve. The average particle size (D50) may be measured by methods well known to those skilled in the art, for example, using a particle size analyzer, a transmission electron microscope photograph, or a scanning electron microscope. In another embodiment, a dynamic light-scattering measurement device is used to perform a data analysis, and the number of particles is counted for each particle size range. From this, the average particle diameter (D50) value may be easily obtained through a calculation.

The Si—C composite may further include a shell surrounding the surface of the Si—C composite, and the shell may include amorphous carbon. The thickness of the shell may be 5 nm to 100 nm.

The amorphous carbon may include soft carbon, hard carbon, mesophase pitch carbide, calcined coke, or mixtures thereof.

The amorphous carbon may be included in an amount of 1 part by weight to 50 parts by weight, for example, 5 parts by weight to 50 parts by weight, or 10 parts by weight to 50 parts by weight, based on 100 parts by weight of the carbon-based active material.

The negative active material layer includes a negative active material and a binder, and may optionally further include a conductive material.

In the negative active material layer, the negative active material may be included in an amount of 95 wt % to 99 wt % based on the total weight of the negative active material layer. An amount of the binder in the negative active material layer may be 1 wt % to 5 wt % based on a total weight of the negative active material layer. In addition, if a conductive material is further included, 90 wt % to 98 wt % of the negative active material, 1 wt % to 5 wt % of the binder, and 1 wt % to 5 wt % of the conductive material may be used.

The binder serves to well attach the negative active material particles to each other and also to well attach the negative active material to the current collector. The binder may be a non-water-soluble binder, a water-soluble binder, or a combination thereof.

The non-water-soluble binder may be an ethylene propylene copolymer, polyacrylonitrile, polystyrene, polyvinyl chloride, carboxylated polyvinylchloride, polyvinyl fluoride, polyurethane, polytetrafluoroethylene, polyvinylidene fluoride, polyethylene, polypropylene, polyamideimide, polyimide, or a combination thereof.

The water-soluble binder may be a styrene-butadiene rubber, an acrylated styrene-butadiene rubber, an acrylonitrile-butadiene rubber, an acrylic rubber, a butyl rubber, a fluoro rubber, an ethylene oxide-containing polymer, polyvinyl pyrrolidone, polyepichlorohydrin, polyphosphazene, an ethylene propylene diene copolymer, polyvinyl pyridine, chlorosulfonated polyethylene, latex, a polyester resin, an acrylic resin, phenolic resin, an epoxy resin, polyvinyl alcohol, or a combination thereof.

If a water-soluble binder is used as the negative electrode binder, a cellulose-based compound capable of imparting viscosity may be further included as a thickener. The cellulose-based compound may include one or more types of carboxymethyl cellulose, hydroxypropylmethyl cellulose, methyl cellulose, or alkali metal salts thereof. The alkali metal may be Na, K, or Li. An amount of the thickener used may be 0.1 parts by weight to 3 parts by weight based on 100 parts by weight of the negative active material.

The conductive material is used to impart conductivity to the electrode, and any material may be used as long as it does not cause chemical change in the battery to be configured and is an electron conductive material. Examples of the conductive material may be a carbon-based material such as natural graphite, artificial graphite, carbon black, acetylene black, ketjen black, denka black, a carbon fiber, and the like; a metal-based material of a metal powder or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof.

The positive electrode includes a current collector and a positive active material layer formed on the current collector and including a positive active material.

The positive active material may include lithiated intercalation compounds that reversibly intercalate and deintercalate lithium ions, specifically one or more composite oxides of a metal selected from cobalt, manganese, nickel, and a combination thereof, and lithium. As a more specific example, a compound represented by any one of the following chemical formulas may be used. LiₐA_{1-b} X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c} D_{c} (0.90≤a≤1.8, 0≤b≤0.5, 0.5≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}Tₐ (0.90≤a≤1.8, 0≤b≤0.5, 0≤c≤0.5, 0<α<2); LiₐNi_{1-b-c}Co_{b}X_{c}O_{2-α}T₂ (0.90≤a≤1.8, 0≤b≤0.5, 0≤c≤0.5, 0<α<2); LiₐNi_{1-b-c}Mn_{b}X_{c}D_{α} (0.90≤a≤1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂(0.90≤a≤1.8, 0.001≤b≤0.1) LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8)

In the above chemical formulas, A is selected from Ni, Co, Mn, and a combination thereof; X is selected from Al, Ni, Co, Mn, Cr, Fe, Mg, Sr, V, rare earth element, and a combination thereof; D is selected from 0, F. S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive active material by using these elements in the compound, and for example, the method may include any coating method (e.g., spray coating, dipping, etc.), but is not illustrated in more detail since it is well-known to those skilled in the related field.

In the positive electrode, an amount of the positive active material may be 90 wt % to 98 wt % based on a total weight of the positive active material layer.

In an embodiment, the positive active material layer may further include a binder and a conductive material. At this time, each amount of the binder and the conductive material may each be 1 wt % to 5 wt % based on a total weight of the positive active material layer.

The binder serves to well attach the positive active material particles to each other and also to well attach the positive active material to the current collector, and examples thereof may be polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is used to impart conductivity to the electrode, and any material may be used as long as it does not cause chemical change in the battery to be configured and is an electron conductive material. Examples of the conductive material may include a carbon-based material such as natural graphite, artificial graphite, carbon black, acetylene black, ketjen black, a carbon fiber, and the like; a metal-based material of a metal powder or a metal fiber including copper, nickel, aluminum, silver, and the like; a conductive polymer such as a polyphenylene derivative; or a mixture thereof.

The current collector may be aluminum foil, nickel foil, or a combination thereof, but is not limited thereto.

The positive active material layer and the negative active material layer are formed by mixing an active material, a binder, and optionally a conductive material in a solvent to prepare an active material composition, and coating this active material composition on a current collector. This method of forming an active material layer is widely known in the art and thus detailed description will be omitted in this specification. The solvent includes N-methyl pyrrolidone and the like, but is not limited thereto. Additionally, when an aqueous binder is used in the negative active material layer, water may be used as a solvent used in preparing the negative active material composition.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, t-butyl acetate, methyl propionate, ethyl propionate, propyl propionate, decanolide, mevalonolactone, caprolactone, and the like. The ether-based solvent may include dibutyl ether, tetraglyme, diglyme, dimethoxyethane, 2-methyltetrahydrofuran, tetrahydrofuran, and the like. In addition, the ketone-based solvent may include cyclohexanone, and the like. The alcohol-based solvent may include ethanol, isopropyl alcohol, and the like and the aprotic solvent may include nitriles such as R—CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, and the like.

The non-aqueous organic solvents may be used alone or in combination with one or more. If the organic solvent is used in a mixture, the mixture ratio may be controlled in accordance with a desirable battery performance.

The carbonate-based solvent is desirably used by mixing a cyclic carbonate and a chain carbonate. In this case, a mixture of cyclic carbonate and chain carbonate in a volume ratio of 1:1 to 1:9 may result in superior electrolyte performance.

If the non-aqueous organic solvent is mixed and used, a mixed solvent of a cyclic carbonate and a chain carbonate, a mixed solvent of a cyclic carbonate and a propionate-based solvent, or a mixed solvent of a cyclic carbonate, a chain carbonate, and a propionate-based solvent may be used. The propionate-based solvent may be methyl propionate, ethyl propionate, propyl propionate, or a combination thereof.

Herein, when the cyclic carbonate and the chain carbonate or the cyclic carbonate and the propionate-based solvent are mixed, they may be mixed in a volume ratio of 1:1 to 1:9 and thus performance of an electrolyte may be improved. In addition, when the cyclic carbonate, the chain carbonate, and the propionate-based solvent are mixed, they may be mixed in a volume ratio of 1:1:1 to 3:3:4. The mixing ratios of the solvents may be appropriately adjusted according to desirable properties.

The non-aqueous organic solvent of the present disclosure may further include an aromatic hydrocarbon-based organic solvent in addition to the carbonate-based solvent. Herein, the carbonate-based solvent and the aromatic hydrocarbon-based organic solvent may be mixed in a volume ratio of 1:1 to 30:1.

The aromatic hydrocarbon-based organic solvent may be an aromatic hydrocarbon-based compound of Chemical Formula 1.

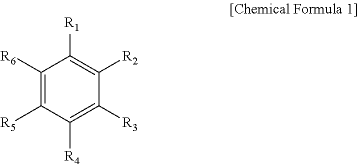

(in Chemical Formula 1, R₁ to R₆ are the same or different and are selected from hydrogen, a halogen, a C1 to C10 alkyl group, a haloalkyl group, and a combination thereof.)

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The non-aqueous electrolyte may further include an additive of vinylene carbonate, or an ethylene carbonate-based compound of Chemical Formula 2 as a cycle-life enhancing additive.

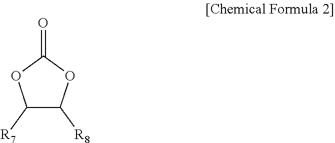

(in Chemical Formula 2, R₇ and R₈ are the same or different, and are selected from hydrogen, a halogen, a cyano group (CN), a nitro group (NO₂), and a fluorinated C1 to C5 alkyl group, provided that at least one of R₇ and R₈ is selected from a halogen, a cyano group (CN), a nitro group (NO₂), and a fluorinated C1 to C5 alkyl group, and R₇ and R₈ are not hydrogen.)

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, or the like. If using more of these cycle-life enhancing additives, the amount used may be adjusted appropriately.

The electrolyte may further include vinylethylene carbonate, propane sultone, succinonitrile, or a combination thereof, and the use amount may be adjusted appropriately.

The lithium salt dissolved in an organic solvent supplies a battery with lithium ions, basically operates the lithium secondary battery, and improves transportation of the lithium ions between positive and negative electrodes. Examples of the lithium salt may include one or two selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiPO₂F₂, LiN(CₓF₂ₓ₊₁SO₂)(C_{y}F_{2y+1}SO₂) where x and y are natural numbers, for example integers of 1 to 20, lithium difluoro(bisoxalato) phosphate, LiCl, LiI, LiB(C₂O₄)₂ (lithium bis(oxalato) borate; LiBOB), and lithium difluoro(oxalato) borate (LiDFOB), as a supporting electrolytic salt. A concentration of the lithium salt may range from 0.1 M to 2.0 M. If the lithium salt is included at the above concentration range, an electrolyte may have excellent performance and lithium ion mobility due to optimal electrolyte conductivity and viscosity.

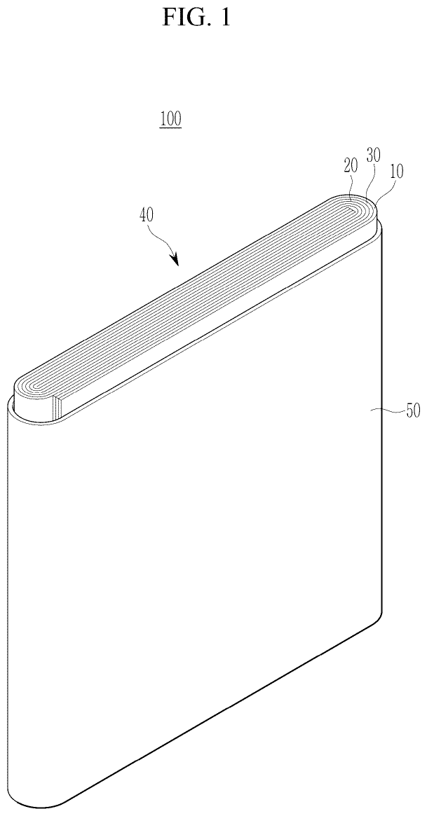

FIG. 1 shows an exploded perspective view of a lithium secondary battery according to an embodiment of the present invention. Although the lithium secondary battery according to an embodiment is described as an example of a prismatic shape, the present invention is not limited thereto and may be applied to batteries of various shapes, such as cylindrical and pouch types.

Referring to FIG. 1, a lithium secondary battery 100 according to an embodiment may include an electrode assembly 40 manufactured by winding a separator 30 disposed between a positive electrode 10 and a negative electrode 20 and a case 50 housing the electrode assembly 40. An electrolyte (not shown) may be impregnated in the positive electrode 10, the negative electrode 20 and the separator 30.

### Mode for Performing the Invention

Hereinafter, examples of the present invention and comparative examples are described. These examples, however, are not in any sense to be interpreted as limiting the scope of the invention.

In the following examples and comparative examples, % concentration means wt %.

### Example 1

### 1. Preparation of Separator

2077.5 g of distilled water and 22.5 g of a poly acrylic acid sodium aqueous solution at a concentration of 40% as a binder were added to 900 g of cubic boehmite with an average particle size (D50) of 0.6 μm (Anhui Estone Materials Technology Co., Ltd.), and the mixture was milled with a bead mill at 25° C. for 30 minutes to prepare 3000 g of boehmite-binder dispersion with a solid amount of 30 wt %.

10.82 g of the prepared boehmite-binder dispersion, 30.85 g of a first polyethylene (PE) wax aqueous solution at a concentration of 40% (average particle size (D50) of polyethylene wax: 1 μm, melting temperature of the polyethylene wax: 110° C., weight average molecular weight (Mw) of polyethylene particles: 1500 g/mol), 1.62 g of a second polyethylene (PE) wax aqueous solution at a concentration of 40% (average particle size (D50) of polyethylene wax: 0.6 μm, melting temperature of the polyethylene wax: 110° C., weight average molecular weight (Mw) of polyethylene particles: 1500 g/mol), 51.23 g of distilled water, and 7.37 g of a polyacryl amide aqueous solution at a concentration of 8.3% were mixed and then, stirred for 1 hour, preparing a coating liquid.

The coating liquid was die-coated on both sides of a 5.5 μm-thick polyethylene porous substrate (SK ie technology Co., Ltd., air permeability: 113 sec/100 cc, puncture strength: 280 kgf, melting temperature: 145° C.) at a thickness of 3.5 μm on both sides (thickness was the sum of the thickness on the both sides, i.e., it was formed on one side at a 1.75 μm thickness), and then dried at 70° C. for 10 minutes to prepare a separator on which the coating layer was formed.

### 2. Fabrication of Half-Cell

94 wt % of artificial graphite, 3 wt % of Ketjen black, and 3 wt % of polyvinylidene fluoride were mixed in an N-methyl pyrrolidone solvent to prepare a negative active material layer composition, and the negative active material layer composition was coated on a copper current collector and then, dried and pressurized to prepare a negative electrode.

The negative electrode, the manufactured separator, and a lithium metal counter electrode were stacked, which was used with an electrolyte to manufacture a half-cell in a common method. The electrolyte was prepared by dissolving 1.5 M LiPF₆ in a mixed solvent of ethylene carbonate, ethylmethyl carbonate, and dimethyl carbonate (in a volume ratio of 2:1:7).

### Example 2

A separator for a lithium secondary battery was manufactured in the same manner as in Example 1 except that 30.2 g of a first polyethylene (PE) wax aqueous solution at a concentration of 40% (average particle size (D50) of polyethylene wax: 1 μm, melting temperature of the polyethylene wax: 110° C., weight average molecular weight (Mw) of polyethylene particles: 1500 g/mol) and 2.27 g of a second polyethylene (PE) wax aqueous solution at a concentration of 40% (average particle size (D50) of polyethylene wax: 0.6 μm, melting temperature of the polyethylene wax: 110° C., weight average molecular weight (Mw) of polyethylene particles: 1500 g/mol) were used.

The separator was used in the same manner as in Example 1 to fabricate a half-cell.

### Example 3

A separator for a lithium secondary battery was manufactured in the same manner as in Example 1 except that 29.23 g of a first polyethylene (PE) wax aqueous solution at a concentration of 40% (average particle size (D50) of polyethylene wax: 1 μm, melting temperature of the polyethylene wax: 110° C., weight average molecular weight (Mw) of polyethylene particles: 1500 g/mol) and 3.24 g of a second polyethylene (PE) wax aqueous solution at a concentration of 40% (average particle size (D50) of polyethylene wax: 0.6 μm, melting temperature of the polyethylene wax: 110° C., weight average molecular weight (Mw) of polyethylene particles: 1500 g/mol) were used.

The separator was used in the same manner as in Example 1 to fabricate a half-cell.

### Example 4

A separator for a lithium secondary battery was manufactured in the same manner as in Example 1 except that 25.98 g of a first polyethylene (PE) wax aqueous solution at a concentration of 40% (average particle size (D50) of polyethylene wax: 1 μm, melting temperature of the polyethylene wax: 110° C., weight average molecular weight (Mw) of polyethylene particles: 1500 g/mol) and 6.49 g of a second polyethylene (PE) wax aqueous solution at a concentration of 40% (average particle size (D50) of polyethylene wax: 0.6 μm, melting temperature of the polyethylene wax: 110° C., weight average molecular weight (Mw) of polyethylene particles: 1500 g/mol) were used.

The separator was used in the same manner as in Example 1 to fabricate a half-cell.

### Comparative Example 1

A separator for a lithium secondary battery was manufactured in the same manner as in Example 1 except that 32.47 g of a first polyethylene (PE) wax aqueous solution at a concentration of 40% (average particle size (D50) of polyethylene wax: 1 μm, melting temperature of the polyethylene wax: 110° C., weight average molecular weight (Mw) of polyethylene particles: 1500 g/mol) and 0 g of a second polyethylene (PE) wax aqueous solution at a concentration of 40% (average particle size (D50) of polyethylene wax: 0.6 μm, melting temperature of the polyethylene wax: 110° C., weight average molecular weight (Mw) of polyethylene particles: 1500 g/mol) were used.

The separator was used in the same manner as in Example 1 to fabricate a half-cell.

### Comparative Example 2

A separator for a lithium secondary battery was manufactured in the same manner as in Example 1 except that 0 g of a first polyethylene (PE) wax aqueous solution at a concentration of 40% (average particle size (D50) of polyethylene wax: 1 μm, melting temperature of the polyethylene wax: 110° C. weight average molecular weight (Mw) of polyethylene particles: 1500 g/mol) and 32.47 g of a second polyethylene (PE) wax aqueous solution at a concentration of 40% (average particle size (D50) of polyethylene wax: 0.6 μm, melting temperature of the polyethylene wax: 110° C., weight average molecular weight (Mw) of polyethylene particles: 1500 g/mol) were used.

The separator was used in the same manner as in Example 1 to fabricate a half-cell.

### Experimental Example 1) Evaluation of Physical Properties

### 1) Evaluation of Air Permeability

The air permeability of the separators according to Examples 1 to 5 and Comparative Examples 1 to 2 were measured, and the results are shown in Table 1. The air permeability experiment was performed by using an air permeability meter (TYPE EG01-55-1MR, ASAHI-SEICO Co., Ltd.) to measure time (seconds) that it took for 100 cc of air to pass each separator. The larger air permeability indicates inappropriate lithium ion movement and it is desirably less than 180 seconds/100 cc.

The results are shown in Table 1. For comparation, the air permeability of the polyethylene porous substrate (air permeability: 113 sec/100 cc, puncture strength: 280 kgf, melting temperature: 145° C., SK ie technology Co., Ltd) was measured, and the increased values relative to this air permeability are shown in Table 1 as “Δ increase value”.

### 2) Evaluation of Impedance (Resistance)

For the half-cells of Examples 1 to 5 and Comparative Examples 1 to 2, impedance (resistance) was measured by using an impedance analyzer (Solartron 1260A Impedance/Gain-Phase Analyzer) at 25° C. under a 2-probe method. Herein, the measurement condition was set to amplitude of ±10 mV and frequency range of 0.1 Hz to 1 MHz. The results are shown in Table 1.

A weight per area of the coating layer and the density of the coating layer are shown in Table 1.

TABLE 1

| | | | | | Comparative | Comparative |
|---|---|---|---|---|---|---|
| | Example 1 | Example 2 | Example 3 | Example 4 | Example 1 | Example 2 |
| First PE (1 μm):second | 95:5 | 93:7 | 90:10 | 80:20 | 100:0 | 0:100 |
| PE (0.6 μm) (weight | | | | | | |
| ratio) | | | | | | |
| Total thickness (μm) | 9 | 9 | 9 | 9 | 9 | 9 |
| Coating thickness (μm) | 3.5 | 3.5 | 3.5 | 3.5 | 3.5 | 3.5 |
| Loading (g/m²) | 2.74 | 2.79 | 2.87 | 3.08 | 2.63 | 4.90 |
| Coating density (g/cm³) | 0.783 | 0.796 | 0.82 | 0.88 | 0.75 | 1.4 |
| Air permeability | 144 (Δ 32) | 144 (Δ 32) | 146 (Δ 34) | 149 (Δ 37) | 153 (Δ 41) | 177 (Δ 65) |
| (sec/100 cc) | | | | | | |
| Resistance (Ω) | 0.61 | 0.63 | 0.65 | 0.73 | 0.82 | 1.38 |

As shown in Table 1, Examples 1 to 4 with the coating layer including the first polyethylene particles and the second polyethylene particles with differing particle sizes, exhibited lower air permeability than Comparative Example 1, and this indicates that the passage of lithium ion may be effectively achieved and the resistance is lower, demonstrating appropriateness.

Comparative Example 2 using only polyethylene wax with low particle diameter of 0.6 μm exhibited improved air permeability, but extremely high resistance, and thus, it is not appropriate.

### Comparative Example 3

A separator for a lithium secondary battery was manufactured in the same manner as in Example 1 except that 30.85 g of a first polyethylene (PE) wax aqueous solution at a concentration of 40% (average particle size (D50) of polyethylene wax: 1 μm, melting temperature of the polyethylene wax: 110° C., and 1.62 g of a second polyethylene (PE) wax aqueous solution at a concentration of 40% (average particle size (D50) of polyethylene wax: 0.1 μm, melting temperature of the polyethylene wax: 110° C.) were used.

The separator was used in the same manner as in Example 1 to fabricate a half-cell.

### Comparative Example 4

A separator for a lithium secondary battery was manufactured in the same manner as in Example 1 except that 30.85 g of a first polyethylene (PE) wax aqueous solution at a concentration of 40% (average particle size (D50) of polyethylene wax: 1 μm, melting temperature of the polyethylene wax: 110° C., weight average molecular weight (Mw) of polyethylene particles: 1500 g/mol) and 1.62 g of a second polyethylene (PE) wax aqueous solution at a concentration of 40% (average particle size (D50) of polyethylene wax: 0.3 μm, melting temperature of the polyethylene wax: 110° C., weight average molecular weight (Mw) of polyethylene particles: 1500 g/mol) were used.

The separator was used in the same manner as in Example 1 to fabricate a half-cell.

### Reference Example 1

A separator for a lithium secondary battery was manufactured in the same manner as in Example 1 except that 30.85 g of a first polyethylene (PE) wax aqueous solution at a concentration of 40% (average particle size (D50) of polyethylene wax: 1 μm, melting temperature of the polyethylene wax: 110° C., weight average molecular weight (Mw) of polyethylene particles: 1500 g/mol) and 1.62 g of a second polyethylene (PE) wax aqueous solution at a concentration of 40% (average particle size (D50) of polyethylene wax: 1.5 μm, melting temperature of the polyethylene wax: 110° C.) were used.

The separator was used in the same manner as in Example 1 to fabricate a half-cell.

### Experimental Example 2) Evaluation of Physical Properties

### 1) Evaluation of Air Permeability

The air permeability of the separators according to Comparative Examples 3 and 4, and Reference Example 1 to 2 were measured, and the results are shown in Table 2. The air permeability experiment was performed by using an air permeability meter (TYPE EG01-55-1MR, ASAHI-SEICO Co., Ltd.) to measure time (seconds) that it took for 100 cc of air to pass each separator.

For comparison, the result of Example 1 is also shown in Table 2.

2) Evaluation of Air Permeability after Heat Exposure

After maintaining the separators according to Example 1, Comparative Example 3, Comparative Example 4, and Reference Example 1 at 120° C. for 60 minutes, the air permeability was measured by the same procedure to the above. The results are shown in Table 2.

### 3) Evaluation of Impedance (Resistance)

For the half-cells of Comparative Examples 3 and 4, Examples 1, and Reference Example 1, impedance (resistance) was measured by using an impedance analyzer (Solartron 1260A Impedance/Gain-Phase Analyzer) at 25° C. under a 2-probe method. Herein, the measurement condition was set to amplitude of 10 mV and frequency range of 0.1 Hz to 1 MHz. The results are shown in Table 2.

TABLE 2

| | | Compar- | Compar- | |
|---|---|---|---|---|
| | Ex- | ative Ex- | ative Ex- | Reference |
| | ample 1 | ample 3 | ample 4 | Example 1 |
| First PE average | 1:0.6 | 1:0.1 | 1:0.3 | 1:1.5 |
| size (μm):second PE | | | | |
| average size (μm) | | | | |
| First PE:second PE | 95:5 | 95:5 | 95:5 | 95:5 |
| (weight ratio) | | | | |
| Total thickness (μm) | 9 | 9 | 9 | 9 |
| coating thickness (μm) | 3.5 | 3.5 | 3.5 | 3.5 |
| Loading (g/m²) | 2.74 | 5.3 | 3.885 | 1.575 |
| Coating density | 0.783 | 1.52 | 1.11 | 0.45 |
| (g/cm³) | | | | |
| Air permeability | 144 | 192 | 167 | 132 |
| (sec/100 cc) | (Δ 32) | (Δ 80) | (Δ 55) | (Δ 20) |
| Air permeability, | 23250 | 30422 | 26836 | 5212 |
| after heat | | | | |
| exposure at 120° C. | | | | |
| (sec/100 cc) | | | | |
| Resistance (Ω) | 0.61 | 0.58 | 0.55 | 0.19 |

As shown in Table 2, Example 1 with the coating layer including the first polyethylene particles with the average size of 1 μm and the second polyethylene particles with the average size of 0.6 μm, exhibited lower air permeability than Comparative Examples 3 and 4, and thus, the lithium ion movement may be effectively exhibited. In case of Example 1, the air permeability was largely decreased after heat exposure at 120° C. From these results, it may be shown that the effect of dosing the pores of the porous substrate by melting the first and the second polyethylene particles included in the coating layer of the separator when it was exposed to a high temperature is excellent in Example 1. In case of Comparative Example 3, the air permeability after heat exposure at 120° C. is appropriate, but, as described in above, the air permeability before heat exposure is extremely higher than the reference value of 180 sec/100 cc and thus, the lithium ion movement is not effectively occurred, indicating it is not suitable for using. Comparative Example 4 exhibited the suitable air permeability after heat exposure at 120° C., but high air permeability at a room temperature, indicating inappropriately lithium ion passage.

Reference Example 1 in which polyethylene particles with larger average particle diameter was used in a smaller amount than polyethylene particles with smaller average particle diameter exhibited smaller air permeability at a room temperature than Example 1, but very smaller air permeability when heat exposure at a high temperature than Example 1, and thus, the shutdown effects are surprisingly low, for example, the shutdown is not sufficiently occurred.

### Comparative Example 5

A separator for a lithium secondary battery was manufactured in the same manner as in Example 1 except that 30.85 g of a polyethylene (PE) wax aqueous solution at a concentration of 40% (average particle size (D50) of polyethylene wax: 1 μm, melting temperature of the polyethylene wax: 110° C., weight average molecular weight (Mw) of polyethylene particles: 1500 g/mol), and 1.62 g of an acrylate particles aqueous solution at a concentration of 40% (a solution in which acrylate particles were distributed in water and average particle size (D50) of acrylate particles: 0.6 μm) were used.

The separator was used in the same manner as in Example 1 to fabricate a half-cell.

### Comparative Example 6

A separator for a lithium secondary battery was manufactured in the same manner as in Example 1 except that 30.85 g of a polyethylene (PE) wax aqueous solution at a concentration of 40% (average particle size (DSO) of polyethylene wax: 1 μm, melting temperature of the polyethylene wax: 110° C., weight average molecular weight (Mw) of polyethylene particles: 1500 g/mol), and 1.62 g of a polyvinylidene fluoride (PVdF) particles aqueous solution at a concentration of 40% (a solution in which polyvinylidene fluoride particles were distributed in water and average particle size (D50) of acrylate particles: 0.6 μm) were used.

The separator was used in the same manner as in Example 1 to fabricate a half-cell.

### Comparative Example 7

A separator for a lithium secondary battery was manufactured in the same manner as in Example 1 except that 30.85 g of a first polyethylene (PE) wax aqueous solution at a concentration of 40% (average particle size (D50) of polyethylene wax: 1 μm, melting temperature of the polyethylene wax: 110° C., weight average molecular weight (Mw) of polyethylene particles: 1500 g/mol), and 1.62 g of an acrylate core-shell particles aqueous solution at a concentration of 40% (core-styrene-butadiene, shell-methylmethacrylate/average particle size (D50) of acrylate core-shell: 0.6 μm) were used.

The separator was used in the same manner as in Example 1 to fabricate a half-cell.

### Experimental Example 3) Evaluation of Physical Properties

### 1) Evaluation of Air Permeability

The air permeability of the separators according to Comparative Examples 5 to 7 were measured, and the results are shown in Table 3. The air permeability experiment was performed by using an air permeability meter (TYPE EG01-55-1MR, ASAHI-SEICO Co., Ltd.) to measure time (seconds) that it took for 100 cc of air to pass each separator. Larger air permeability indicates that ion movement does inappropriately occur.

For comparison, the result of Example 1 is also shown in Table 3.

TABLE 3

| | Ex- | Comparative | Comparative | Comparative |
|---|---|---|---|---|
| | ample 1 | Example 5 | Example 6 | Example 7 |
| Types of first | PE/PE | PE/ | PE/PVdF | PE/ |
| particles/ | | methyl- | | Core-shell |
| second particles | | acrylate | | |
| Total thickness | 9 | 9 | 9 | 9 |
| (μm) | | | | |
| Coating thickness | 3.5 | 3.5 | 3.5 | 3.5 |
| (μm) | | | | |
| Loading (g/m2) | 2.74 | 5.67 | 5.95 | 5.6 |
| Coating density | 0.783 | 1.62 | 1.70 | 1.60 |
| (g/cm3) | | | | |
| Air permeability | 144 | 1162 | 265 | 1163 |
| (sec/100 cc) | (Δ 32 | (Δ 1050) | Δ 153 | (Δ 1051) |

As shown in Table 3, even if using polymer particles of different average sizes, Comparative Examples 5 to 7, which are not polyethylene, exhibited much higher air permeability compared to Example 1, indicating that the movement of lithium ions is not effective.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims. Therefore, the aforementioned embodiments should be understood to be exemplary but not limiting the present invention in any way.

1. A separator for a rechargeable lithium battery, comprising:
a porous substrate; and
a coating layer disposed on at least one surface of the porous substrate and comprising first polyethylene particles, second polyethylene particles, and ceramics,
wherein a ratio of an average size of the second polyethylene particles to an average size of the first polyethylene particles ranges from 25% to 80%.

2. The separator for a rechargeable lithium battery as claimed in claim 1, wherein the average size of the first polyethylene particles is 1 μm to 2 μm.

3. The separator for a rechargeable lithium battery as claimed in claim 1, wherein the average size of the second polyethylene particles is 0.5 μm to 0.8 μm.

4. The separator for a rechargeable lithium battery as claimed in claim 1, wherein a weight average molecular weight (Mw) of one of the first polyethylene particles and the second polyethylene particles is 1000 g/mol to 5000 g/mol.

5. The separator for a rechargeable lithium battery as claimed in claim 1, wherein a mixing ratio of the first polyethylene particles to the second polyethylene particles is 70:30 to 95:5 by weight ratio.

6. The separator for a rechargeable lithium battery as claimed in claim 1, wherein the ceramics comprise at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, and boehmite.

7. The separator for a rechargeable lithium battery as claimed in claim 1, wherein the coating layer further comprises an aqueous binder.

8. The separator for a rechargeable lithium battery as claimed in claim 1, wherein the aqueous binder comprises at least one of a styrene-butadiene rubber, an acrylated styrene-butadiene rubber, polyvinyl alcohol, sodium polyacrylate, a copolymer of propylene and a C2 to C8 olefin, a copolymer polyacryl amide, and a copolymer of (meth)acrylic acid and (meth)acrylic acid alkyl ester.

9. The separator for a rechargeable lithium battery as claimed in claim 1, wherein the coating layer has a thickness of 0.5 μm to 5 μm on one side thereof.

10. The separator for a rechargeable lithium battery as claimed in claim 1, wherein the separator further comprises an adhesive layer disposed on one surface of the coating layer.

11. The separator for a rechargeable lithium battery as claimed in claim 10, wherein the adhesive layer comprises at least one of a fluorine-included binder and a vinyl group-containing binder.

12. The separator for a rechargeable lithium battery as claimed in claim 11, wherein the fluorine-included binder comprises at least one of a polyvinylidene fluoride binder, a polyvinylidene fluoride-hexafluoropropylene copolymer binder, and a polytetrafluoroethylene binder.

13. The separator for a rechargeable lithium battery as claimed in claim 11, wherein the vinyl group-containing binder comprises at least one of (meth)acrylic acid, methyl(meth)acrylate, (meth)acrylonitrile, (meth)acrylamidosulfonic acid, and (meth)acrylamidosulfonate salt.

14. The separator for a rechargeable lithium battery as claimed in claim 11, wherein the adhesive layer has a thickness of 0.1 μm to 4 μm on one side.

15. A rechargeable lithium battery, comprising:
a negative electrode comprising a negative active material;
a positive electrode comprising a positive active material;
the separator as claimed in claim 1, between the negative electrode and the positive electrode; and
non-aqueous electrolyte.
